(19) United States
(12) Patent Application Publication
(10) Pub. No.: US 2025/0163294 A1
(43) Pub. Date: May 22, 2025

(54) EPOXY COATING WITH EXCELLENT CHEMICAL RESISTANCE AND IMPROVED HEALTH AND SAFETY

(71) Applicant: Advanced Polymer Coatings, Inc., Avon, OH (US)

(72) Inventors: Jeremy Pasatta, Olmsted Falls, OH (US); Jenna Wagner, Westlake, OH (US)

(73) Assignee: Advanced Polymer Coatings, Inc., Avon, OH (US)

(21) Appl. No.: 18/953,234

(22) Filed: Nov. 20, 2024

Related U.S. Application Data
(60) Provisional application No. 63/600,769, filed on Nov. 20, 2023.

(51) Int. Cl. C09D 163/04; B05D 1/02; B05D 7/16; C08K 3/04; C08K 3/22; C08K 3/30; C08K 3/36; C08K 5/3445; C09D 7/61; C09D 7/63; C09D 7/65; C09D 7/80

(52) U.S. Cl. CPC C09D 163/04; B05D 1/02; B05D 7/16; C08K 3/04; C08K 3/36; C08K 5/3445; C09D 7/61; C09D 7/63; C09D 7/65; C09D 7/80; B05D 2202/15; B05D 2504/00; C08K 2003/2241; C08K 2003/3045

(57) ABSTRACT

A coating composition includes an epoxy diluent and a higher functionality epoxy novolac resin and may be cured with a cycloaliphatic amine curing agent and a latent curing agent. The coating composition may be devoid of solvents. A coating process includes forming the coating composition, depositing the coating composition on a substrate, evaporating a solvent (if present) from the deposited coating composition, and curing the coating composition. An article includes a substrate and a coating layer formed from the coating composition.

This application claims priority to U.S. Provisional Application Ser. No. 63/600,769 filed Nov. 20, 2023, the contents of which are incorporated by reference herein.

### BACKGROUND

The present exemplary embodiment relates to an epoxy-based coating that gives excellent chemical resistance to chemicals traded in the marine industry and also has an improved health and safety profile over leading epoxy-based coatings in the industry. Curing may be at ambient temperature or elevated temperature using both an amine curative and latent curing agents.

It would be desirable to develop new coatings that exhibit excellent chemical resistance to chemicals traded in the marine industry, good adhesion, gloss and cleanability while having less impact to the health and safety of workers compared to leading coatings in the industry. Use of an epoxy diluent in combination with a higher functionality epoxy novolac and cured with a cycloaliphatic amine combined with a latent curing agent gives this combination for properties. The epoxy diluent should have low viscosity, excellent chemical resistance, and adhesion, give excellent chemical resistance, and also give a lower impact to worker health and safety.

### BRIEF DESCRIPTION

A coating composition contains an epoxy diluent and a higher functionality epoxy novolac and is cured with a cycloaliphatic amine combined with a latent curing agent or any other suitable curing agent combination. The composition may further contain a solvent, a filler, and one or more other additives.

The coating composition may contain any epoxy diluent capable of undergoing polymerization with but not limited to an amine-based catalyst. The epoxy diluent may be a multifunctional epoxy with a cyclosiloxane backbone. A preferred epoxy diluent in tetrakisepoxy cyclosiloxane, CAS #257284-60-9.

Furthermore, the coating composition will contain an epoxy novolac resin with functionality greater than 2, preferably with functionality greater than 3.

Furthermore, the coating may contain a solvent that is compatible with the epoxy resins, such as but not limited to xylene and toluene. Ideally, solvent is not necessary in the formulation and the coating can be formulated with 100% solids content.

Furthermore, the coating will contain an amine curing agent that readily reacts with the epoxy at room temperature and is capable of further reacting at elevated temperatures. Examples include but are not limited to cycloaliphatic amines. In some embodiments, the cycloaliphatic amine is 4,4′-methylenebis(cyclohexylamine), CAS #1761-71-3. In other embodiments, the cycloaliphatic amine is isophorone diamine (IPDA). Combinations including both IPDA and 4,4′-methylenebis(cyclohexylamine) are also contemplated.

Furthermore, the coating will contain a latent curing agent that can cure the epoxy resin once exposed to elevated temperatures.

Furthermore, the coating composition may contain a filler. Examples include but are not limited to silica (e.g., crystalline silica), barium sulfate and wollastonite.

Furthermore, the coating composition may contain a rheology modifier. Examples include but are not limited to hydrophobic fumed silica.

Furthermore, the coating may contain additional additives such as adhesion promoters, flow and levelling additives and pigments for coloration and hiding. Hiding refers to the opacity of the coating. The higher the hiding power, the higher the opacity, and the thinner a coating may be applied without the underlying substrate or portions thereof being visible.

The coating may be capable of curing at room temperature in less than 12 hours. Alternatively, the coating can be additionally cured with heat to improve properties.

Further disclosed are processes for applying a coating. The processes include depositing a coating composition containing the composition described, evaporating the solvent (if present), and curing the epoxy resin.

Disclosed, in some embodiments, is a coating composition including: an epoxy diluent; a high functionality epoxy novolac resin; an amine curing agent; and a latent curing agent.

The coating composition may further include a filler; an adhesion promoter; a rheology modifier; and a pigment.

In some embodiments, the coating composition does not contain a solvent.

The coating composition may have a solids content of from about 10 wt % to about 70 wt %, about 15 wt % to about 65 wt %, or about 20 wt % to about 60 wt %.

In some embodiments, the amine curing agent comprises a cycloaliphatic amine curing agent.

The latent curing agent may include an imidazole curing agent.

In some embodiments, the epoxy diluent includes tetrakisepoxy cyclosiloxane.

Disclosed, in other embodiments, is a coating composition kit containing: a first part (A) including an epoxy diluent and a high functionality epoxy novolac resin; and a second part (B) including an amine curing agent and a latent curing agent.

The first part (A) and/or the second part (B) may further contain at least one additive selected from the group consisting of fillers, adhesion promoters, rheology modifiers, and pigments.

In some embodiments, the first part (A) contains: 0.01 to 30 wt % of the high functionality epoxy novolac resin; 5 to 40 wt % of the epoxy diluent; 20 to 70 wt % of a filler; 0 to 5 wt % of an adhesion promoter; 0 to 10 wt % of a first pigment; 0 to 5 wt % of a second pigment; and 0 to 5 wt % of a rheology modifier.

The first part (A) may contain: 5 to 25 wt % of the high functionality epoxy novolac resin; 10 to 35 wt % of the epoxy diluent; 30 to 60 wt % of a filler; 0.01 to 2 wt % of an adhesion promoter; 1 to 9 wt % of a first pigment; 0.01 to 1 wt % of a second pigment; and 0.5 to 3 wt % of a rheology modifier.

In some embodiments, the first part (A) contains: 10 to 20 wt % of the high functionality epoxy novolac resin; 15 to 30 wt % of the epoxy diluent; 35 to 55 wt % of a filler; 0.1 to 0.7 wt % of an adhesion promoter; 2 to 4 wt % of a first pigment; 0.02 to 0.2 wt % of a second pigment; and 0.75 to 1.5 wt % of a rheology modifier.

The second part (B) may contain: 45 to 95 wt % of the amine curing agent; and 5 to 55 wt % of the latent curing agent.

In some embodiments, the second part (B) contains: 50 to 90 wt % of the amine curing agent; and 10 to 55 wt % of the latent curing agent.

The second part (B) may contain: 55 to 85 wt % of the amine curing agent; and 15 to 45 wt % of the latent curing agent.

In some embodiments, neither the first part (A) nor the second part (B) contains a solvent. In other embodiments, only one of the first part (A) and the second part (B) contains a solvent. In further embodiments, both parts (A) and (B) contain a solvent.

The coating composition may be deposited on a substrate via airless spray deposition.

In some embodiments, the curing is performed at ambient temperature or at an elevated temperature to improve properties and/or increase curing rate.

These and other non-limiting characteristics are more particularly described below.

### BRIEF DESCRIPTION OF THE DRAWINGS

FIG. 1 is a flow chart illustrating a non-limiting example of a coating process in accordance with some embodiments of the present disclosure.

FIG. 2 is a side cross-sectional view of a coated article in accordance with some embodiments of the present disclosure.

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The present disclosure relates to a coating composition containing an epoxy diluent and a higher functionality epoxy novolac cured with cycloaliphatic amines in combination with latent curing agents.

Epoxy novolac resins include a phenol-formaldehyde backbone structure with epoxy groups attached thereto. The number of epoxy groups may not be identical for each molecule in the resin. The term “high functionality epoxy novolac resin” as used herein indicates that the average number of epoxy groups per molecule is at least 2. In particular embodiments, the average number is at least 2.5, at least 3.0, at least 3.1, at least 3.2, at least 3.3, at least 3.4, or at least 3.5.

The coating composition uses an epoxy diluent that has very low viscosity (e.g., 1-5,000 cP, 5-3,000 cP, or 10-2,000 cP) but also has very good chemical resistance (e.g., does not blister, crack or delaminate when expose continuously to the chemical—for thin chip and panel immersions, weight gain or loss should be less than 15%) and does not greatly affect the health and safety of workers. Viscosity is measured at 25° C. and may be measured using a Brookfield DVII+ or equivalent viscometer. Current industrial coatings can use resorcinol diglycidyl ether (RDGE) as the epoxy diluent that gives very low viscosity and excellent chemical resistance, but RDGE can cause a dermal allergic reaction. RDGE is normally combined with functionality greater than three to provide the best chemical resistance. Surprisingly, it has been found that tetrakisepoxy cyclosiloxane is an epoxy diluent that has very low viscosity and when used in combination with an epoxy novolac with functionality greater than three gives excellent chemical resistance to chemicals traded in the marine chemical tanker industry. In contrast to RDGE, tetrakisepoxy cyclosiloxane does not cause dermal severe dermal irritation. Without wishing to be bound by theory, it is believed that the stated benefits of tetrakisepoxy cyclosiloxane result from the inorganic nature of the backbone which improves chemicals resistance, and the presence of four epoxy groups, which improves crosslink density and chemical resistance. In addition, the cyclosiloxane backbone of the epoxy diluent improves the flexibility of the coating. The low viscosity of tetrakisepoxy cyclosiloxane also allows the coating to be formulated without the use of solvent, which because of the low or no VOCs has an improved impact on the environment. To further improved chemical resistance, tetrakisepoxy cyclosiloxane is combined with an epoxy novolac with functionality greater than 2, preferably with functionality greater than 3. These epoxy resins give excellent chemical resistance, but are very high in viscosity, and therefore must be combined with either an epoxy diluent or solvent to achieve a coating that is capable of being applied to a substrate by conventional methods such as airless spray. To achieve the maximum chemical resistance, the coating should be cured with curing agents that allow for the coating to dry at room temperature, give excellent chemical resistance, but are also capable of giving full cure at elevated temperatures. The use of latent curing agents promotes epoxy homopolymerization, which further enhances the chemical resistance of the coating. Examples of amines that accomplish the stated objects include but are not limited to cycloaliphatic amines and the latent curing agents that accomplish the stated objectives include but are not limited to imidazoles. The amine curing agent should also give dry times less than 12 hours for applications that require fast return to service, and when combined with a latent curing agent, should achieve final cure in temperatures less than 145° C. in less than 6 hours. The coating composition may also contain a high degree of filler to reduce overall coating cost and improve coating properties. These fillers are commonly known in the industry and examples include but are not limited to silica, barium sulfate and wollastonite. The formulation may also include other coating additives such as fumed silica, adhesion promoters, pigments for coloring and hiding power and flow and levelling agents.

The coating composition may be provided in two parts, A and B. Providing the composition in parts A and B may have advantages such as avoiding premature reactions. Non-limiting examples of compositions for parts A and B are provided in Tables 1 and 2 below.

TABLE 1
Non-Limiting Examples for Part A

| | | Broad | Intermediate | Narrow |
|---|---|---|---|---|
| Component | Example | (wt %) | (wt %) | (wt %) |
| Epoxy | D.E.N. 438 | 0.01-30 | 5-25 | 10-20 |
| Novolac | (functionality ~3.6) | | | |
| Resin | | | | |
| Epoxy | PEL-SIL | 5-40 | 10-35 | 15-30 |
| Diluent | CK100 | | | |
| Filler | Cimbar XF | 20-70 | 30-60 | 35-55 |
| Adhesion | Silquest A-187 | 0-5 | 0.01-2 | 0.1-0.7 |
| Promoter | | | | |
| Pigment | TR90 TiO2 | 0-10 | 1-9 | 2-4 |
| Rheology | Aerosil R202 | 0-5 | 0.5-3 | 0.75-1.5 |
| Modifier | | | | |
| Pigment | LB1011 | 0-5 | 0.01-1 | 0.02-0.2 |
| | Carbon Black | | | |

TABLE 2
Non-Limiting Examples for Part B

| | | Broad | Intermediate | Narrow |
|---|---|---|---|---|
| Component | Example | (wt %) | (wt %) | (wt %) |
| Cycloaliphatic | AMICURE ® | 45-95 | 50-90 | 55-85 |
| Amine Curing | PACM | | | |
| Agent | | | | |
| Imidazole | 2,4-EMI-NJ | 5-55 | 10-50 | 15-45 |
| Latent Curing | | | | |
| Agent | | | | |

Ratio of A:B will depend on the amine and epoxy used; this will dictate stoichiometry. A:B ratio can also depend on filler and solvent level. The level of curing agent is normally done at a level much lower than stoichiometric due to the presence of latent curing agents, which are used at a catalytic amount. Typical levels of curing agents based on the representative compositions given in Table 1 are 100 parts by weight of Part A to 6 to 8 parts by weight of Part B.

Parts A and B are not limited to the specific materials or types of materials discussed above.

It should be understood that this is merely a representative example and any individual non-epoxy component, or any combination thereof may be included in PART B instead of PART A. In some embodiments, this is done to balance mix ratios to be able to apply the coating with a plural component sprayer, which works off of fixed A:B volumetric ratios, such as 1:1, 2:1 and 4:1. It is also contemplated that the amount of any non-epoxy component may be split between PARTS A and B.

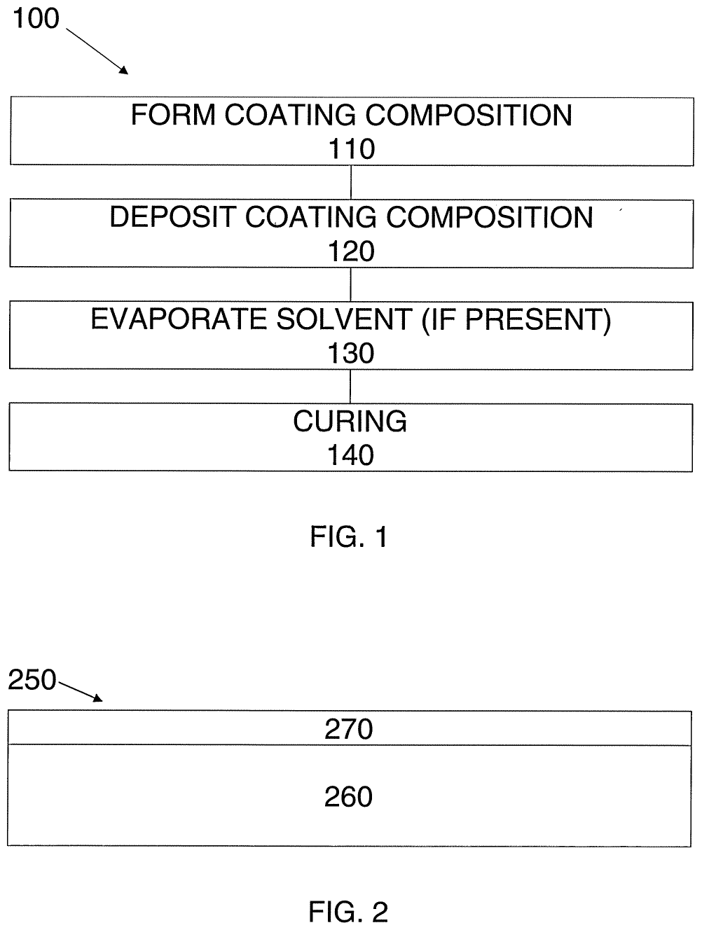

FIG. 1 is a flow chart illustrating a non-limiting example of a coating process 100 in accordance with some embodiments of the present disclosure. The process 100 includes forming a coating composition 110, depositing the coating composition on a substrate 120, evaporating a solvent (if present in the coating composition) 130, and curing the deposited coating composition 140.

In some embodiments, the coating composition is formed 110 by mixing a first part (A) and a second part (B).

The coating composition may be deposited 120 on the substrate using any suitable application step. In particular embodiments, airless spray application is used.

When the coating composition contains a solvent, the solvent may be partially or completely evaporated 130.

Curing 140 encompasses both the amine-curing of the epoxy resin and the heat activated curing of the imidazole curing agent.

It should be noted that one or more steps may be repeated to form a coating with a desired thickness.

FIG. 2 is a side cross-sectional view of a coated article 250 in accordance with some embodiments of the present disclosure. The article includes a substrate 260 with a coating layer 270 deposited thereof. The substrate 260 may be a monolayer or a multilayer substrate. Typical substrates are steel substrates, with carbon steel being the most typically used metal substrate. The coating layer 270 is formed from the coating composition described herein and may be formed in a single coating or multiple coatings.

The following examples are provided to illustrate the devices and methods of the present disclosure. The examples are merely illustrative and are not intended to limit the disclosure to the materials, conditions, or process parameters set forth therein.

### EXAMPLES

### Example 1: Coating Composition Containing Novel Epoxy Diluent

TABLE 3
PART A

| COMPONENT | AMOUNT (parts by weight) |
|---|---|
| D.E.N. 438 (Phenolic epoxy resin, | 120.4 |
| functionality 3.6) | |
| PEL-SIL CK100 (Tetrakisepoxy | 180.6 |
| cyclosiloxane) | |
| Cimbar XF (Barium sulfate) | 301 |
| Silquest A-187 (Adhesion promoter) | 2.45 |
| Titanium dioxide (Pigment) | 21.0 |
| Aersoil R202 (Rheology modifier) | 7.0 |
| LB1011 Carbon Black (Pigment) | 0.3 |

D.E.N. 438, PEL-SIL CK100 and Silquest A-187 are combined in a suitable container equipped with a Cowles mixing blade. The components are stirred until homogeneous, approximately 5 minutes. The stirring rate is then increased and the Cimbar XF is slowly added, and this mixture is allowed to stir at high shear rates for 10-15 minutes. After this time, the carbon black and titanium dioxide are added and allowed to stir at high shear rates for 2-3 minutes. The Aerosil R202 is then added, and the mixture is allowed to stir at high shear rates for 10 minutes.

TABLE 4
PART B

| COMPONENT | AMOUNT (parts by weight) |
|---|---|
| Amicure PACM (cycloaliphatic amine) | 31.76 |
| 2,4-EMI-NJ (imidazole) | 13.61 |

Amicure PACM and 2,4-EMI-NJ are added to a mixing vessel equipped with a Cowles type mixing blade and allowed to mix until homogeneous.

Part A and Part B are then thoroughly combined to give a coating composition capable of being applied via airless spray with the following properties:

| | | |
|---|---|---|
| Gel time (Shyodu gel timer) | 249 | min |
| Sag resistance | 60 | mil+ |

The coating was mixed at 100 parts by weight of Part A and 7.2 Parts by weight of Part B and was drawn down in a 15-mil film and cured at 145° C. for 6 hours, after which time it was cut into small pieces and fully immersed in chemicals that are typically traded in the marine chemical tanker industry. Immersion testing was done in small glass jars at elevated temperatures, and after one week, the samples were removed from the jar, rinsed with water and allowed to dry at ambient for several hours after which time they were weighed and compared to the original weight to determine the percent weight change. These chemical immersion thin coating chips were then compared with MarineLINE® 784 thin coating chips cured at the manufacturer's recommended curing temperature. MarineLINE® 784 is considered the highest chemical resistance coating for the marine chemical tanker industry but contains RDGE and can therefore be a dermal irritant. Weight changes below 15% are considered acceptable in this type of immersion testing conducted at 40° C. Table 5 shows that the representative composition gives weight change very close to those of MarineLINE® 784, and below the 15% weight change that is considered acceptable for this type of testing.

TABLE 5
Chemical Immersion Testing

| | % Weight Change, 1 week, 40′ C. | |
|---|---|---|
| | Representative | |
| Chemical | Composition | MarineLINE ® 784 |
| Methanol | 1.0 | 3.4 |
| Toluene | 0.2 | −0.3 |
| Methyl Acetate | 1.8 | −0.3 |
| Xylene | 0.6 | −0.2 |
| Ethylene Dichloride | 4.4 | 0.0 |
| Methyl ethyl ketone (MEK) | 0.1 | 0.2 |
| Acrylonitrile | 2.7 | 3.8 |
| Styrene | 0.6 | −0.3 |
| Used Cooking Oil (UCO) | 0.8 | −0.2 |
| Palm Fatty Acid Distillate | 1.8 | 0.5 |
| (PFAD) | | |

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A coating composition comprising:
an epoxy diluent;
a high functionality epoxy novolac resin;
an amine curing agent; and
a latent curing agent.

2. The coating composition of claim 1, further comprising:
a filler;
an adhesion promoter;
a rheology modifier; and
a pigment.

3. The coating composition of claim 1, wherein the coating composition does not contain a solvent.

4. The coating composition of claim 1, wherein the coating composition has a solids content of from about 10 wt % to about 70 wt %.

5. The coating composition of claim 1, wherein the coating composition has a solids content of from about 15 wt % to about 65 wt %.

6. The coating composition of claim 1, wherein the coating composition has a solids content of from about 20 wt % to about 60 wt %.

7. The coating composition of claim 1, wherein the amine curing agent comprises a cycloaliphatic amine curing agent.

8. The coating composition of claim 1, wherein the latent curing agent comprises an imidazole curing agent.

9. The coating composition of claim 1, wherein the epoxy diluent comprises tetrakisepoxy cyclosiloxane.

10. A coating composition kit comprising:
a first part (A) comprising:
an epoxy diluent; and
a high functionality epoxy novolac resin; and
a second part (B) comprising:
an amine curing agent; and
a latent curing agent.

11. The coating composition kit of claim 10, wherein the first part (A) further comprises:
at least one additive selected from the group consisting of fillers, adhesion promoters, rheology modifiers, and pigments.

12. The coating composition kit of claim 10, wherein the first part (A) comprises:
0.01 to 30 wt % of the high functionality epoxy novolac resin;
5 to 40 wt % of the epoxy diluent;
20 to 70 wt % of a filler;
0 to 5 wt % of an adhesion promoter;
0 to 10 wt % of a first pigment;
0 to 5 wt % of a second pigment; and
0 to 5 wt % of a rheology modifier.

13. The coating composition kit of claim 10, wherein the first part (A) comprises:
5 to 25 wt % of the high functionality epoxy novolac resin;
10 to 35 wt % of the epoxy diluent;
30 to 60 wt % of a filler;
0.01 to 2 wt % of an adhesion promoter;
1 to 9 wt % of a first pigment;
0.01 to 1 wt % of a second pigment; and
0.5 to 3 wt % of a rheology modifier.

14. The coating composition kit of claim 10, wherein the first part (A) comprises:
10 to 20 wt % of the high functionality epoxy novolac resin;
15 to 30 wt % of the epoxy diluent;
35 to 55 wt % of a filler;
0.1 to 0.7 wt % of an adhesion promoter;
2 to 4 wt % of a first pigment;
0.02 to 0.2 wt % of a second pigment; and
0.75 to 1.5 wt % of a rheology modifier.

15. The coating composition kit of claim 10, wherein the second part (B) comprises:
45 to 95 wt % of the amine curing agent; and
5 to 55 wt % of the latent curing agent.

16. The coating composition kit of claim 10, wherein the second part (B) comprises:
50 to 90 wt % of the amine curing agent; and
10 to 55 wt % of the latent curing agent.

17. The coating composition kit of claim 10, wherein the second part (B) comprises:
55 to 85 wt % of the amine curing agent; and
15 to 45 wt % of the latent curing agent.

18. A coating process comprising:
forming a coating composition by mixing
a first part comprising:
an epoxy diluent; and
a high functionality epoxy novolac resin; and
a second part comprising:
a latent curing agent; and
an amine curing agent;
depositing the coating composition onto a substrate; and
curing the coating composition to form a coating layer.

19. The coating process of claim 18, wherein neither the first part (A) nor the second part (B) contains a solvent.

20. The process of claim 18, wherein the depositing comprises airless spray deposition; and/or wherein the curing is performed at ambient temperature or at an elevated temperature to improve properties and/or increase curing rate.
